(19) United States
(12) Patent Application Publication
(10) Pub. No.: US 2011/0114687 A1
(43) Pub. Date: May 19, 2011

(54) Open face gun case for utility vehicle

(76) Inventor: Michael Wellborn, Amarillo, TX (US)

(21) Appl. No.: 12/592,029

(22) Filed: Nov. 18, 2009

(51) Int. Cl. B60R 9/02; F41C 33/06; B60R 9/08

(52) U.S. Cl. 224/401; 206/317; 224/533

(57) ABSTRACT

The easily accessible, vehicle mounted firearm case of the invention includes an elongate body having a length and width sufficient to accommodate a long gun style firearm. The elongate body has an exterior and an interior which is defined by a pair of parallel side panels separated by a back panel. The case has a fixed elongated front opening, located opposite the back panel which allows insertion and removal of a firearm without requiring unlatching of the front opening. The interior of the case body is lined with a resilient engagement material which holds the firearm in place during transport of the case. The gun case can be mounted on an exterior location on the ATV. The case is mounted in a forwardly slanted position whereby the firearm is partly retained in the case interior by gravity.

### BACKGROUND OF THE INVENTION

1. Field of the Invention

The present invention relates generally to a vehicle-mounted firearm enclosure and, more specifically, to a firearm enclosure which secures the firearm within reach of the driver or the passenger of a utility vehicle such as an all-terrain vehicle (ATV) while simultaneously allowing easy retrieval of the firearm without unlocking or unlatching the secure enclosure.

2. Description of the Prior Art

Modern firearms represent a significant investment and also may have value as heirlooms or for sentimental reasons and the like. In order to ensure that the firearm retains a significant portion of its value, it is necessary to maintain the firearm in good condition, both mechanically and cosmetically.

For these and other reasons, a variety of different types of gun “cases” have been developed over the years, including both those of both the “soft” and “hard” cases. Soft cases are typically some sort of sleeve (usually of outer fabric or leather) with a padded interior. Access to the interior of the soft case is often with a zipper or hook and loop fastener, or other well known means. Hard cases may be made of metal such as aluminum, wood, or various plastics. Usually, hard cases are hinged, pieces of luggage, with foam inserts or the like inside to conform to the shape of the gun. These cases also usually have a latching mechanism of some sort which must be unlatched to provide access to the firearm.

While the above-described cases generally satisfactorily protect guns, most of them do not provide very quick access to the gun. By design, in order to increase protection and/or security, openings of different sorts must be accessed to get the gun out. In certain situations, it is desired to maintain a gun in a readily accessible position inside or on a vehicle, yet still maintain a high degree of protection for the gun. For example, deer hunting or feral pig hunting are popular in many areas of the country and may involve driving a vehicle (such as a pickup truck or SUV) down roads in game populated areas in order to sight game animals. Once a game animal is sighted, the vehicle is stopped, the hunter gets his or her gun into position (shooting either from within or without the vehicle) and the shot is taken.

It will be appreciated that the elapsed time from sighting the animal until the shot is taken is usually a short interval or the animal will become spooked and leave the scene. In order to minimize time, the gun is often loaded, with ammunition in the magazine if not chambered; and the gun must obviously be in an accessible location. In addition to sport hunters, other gun users may also have a need for secure, but readily accessed device for holding guns in or on vehicles. For example, farmers and ranchers often carry a gun to use for pest and varmint control.

In these situations, a frequent way of carrying the gun is to physically hold it with the muzzle pointing either straight up or angled down at the floorboard of the vehicle. The driver, however, must generally have both hands available for driving. As a result, a typical practice has been to keep the gun simply muzzle-down on the floorboard, with the end of the barrel on the floorboard, and the mid-section of the gun resting on the seat. The grip and butt of the gun are therefore readily accessible. But this practice has numerous drawbacks. Since the gun is not really held in place by any restraints, safety is compromised as the gun can slide around, the muzzle potentially point at the driver or a passenger's foot or leg. In the case of a scoped rifle, the telescopic sight can be cosmetically or functionally damaged by banging against the interior of the vehicle. While certain gun holders have been devised to hold guns in or on vehicles, generally such holders do not provide complete protection for the gun, as most of the length of the gun is not covered, but is exposed and subject to scratching, etc.

Another attempt to meet these needs has resulted in the development of various vehicle mounted “racks” for carrying long guns on all-terrain vehicles (ATVs). Presently available gun mounting racks and cases do not fulfill a present need for a lightweight, easy-to-mount, secure gun mount for carrying a gun, which protects the gun and on-lookers, yet allows the owner to quickly mount and then remove the gun.

These and other problems give rise to the need for a gun holder which keeps a gun at a readily accessible position within the vehicle, for easy access by occupants of the vehicle; yet at the same time restrains the gun in place so as to increase safety and protect against damage, and in addition covers substantially all of the length of the gun. In addition, it is desired to have such a gun holder which is adapted to use in many different vehicles without customization to each, and which is of simple and inexpensive construction.

### SUMMARY OF THE INVENTION

The open face gun case of the invention provides a mounting mechanism that will secure the firearm near the driver or passenger while simultaneously allowing easy retrieval of the firearm without unlocking or unlatching a sealed enclosure.

Therefore, it can be appreciated that such a design will provide a mounting mechanism, particularly for a long gun that will increase the speed of retrieval of the hunter's firearm.

The device of the present invention combines the advantages of: a soft gun glove or carrying case by protecting the gun finish from marring; a gun boot by allowing easy access to the gun and mounting on or in a vehicle; and a hard-cover carrying case by protecting the gun from impact.

The open face gun case of the present invention is lightweight, versatile, and easily mounted in or on a vehicle. This device can, if desired, be easily detached from the vehicle and reattached to a wall or brackets in a garage or closet, for example, for storage. The device of the present invention provides both soft and hard cover-type protection in one unit. Here, the case is itself the mounting device; there is no need for enclosing the gun first in a soft scabbard, and then in a mounting device. The soft interior of the case of the invention protects the gun's finish from mars and absorbs shock. The relatively rigid outer case helps to protect the gun inside from hard bumps and accidental discharges.

The easily accessible, vehicle mounted firearm case of the invention includes an elongate body having a length and width sufficient to accommodate a long gun style firearm. The elongate body has an exterior and an interior which is defined by a pair of parallel side panels separated by a back panel. The case has a fixed elongated front opening, located opposite the back panel which allows insertion and removal of a firearm without requiring unlatching of the front opening. The interior of the case body is lined with a resilient engagement material which holds the firearm in place during transport of the case. Preferably, the engagement material is a poly fiber material lined with fleece.

The gun case of the invention is preferably used in combination, with an all-terrain vehicle having an exterior and an interior with a driver side and a passenger side. The previously described gun case is mounted with suitable mounting hardware for mounting the firearm case on an exterior location on the ATV. The case is mounted in a preselected position which is rotated forward of a vertical axis away from the vehicle interior, and away from the driver side and passenger side, whereby the firearm is partly retained in the case interior by gravity.

The case interior has a boot region which retains the butt region of the stock of the firearm, whereby retrieving the firearm from the case interior requires rotating the firearm in the direction of the elongate front opening and lifting it out of the captive boot region when mounted in the previously described mounting position. In this preferred configuration, the firearm is held within the interior of the gun case by gravity and contact with the fleece lining in combination with the boot region located at the bottom of the case interior.

### BRIEF DESCRIPTION OF THE DRAWINGS

FIG. 1 is a perspective view of an ATV having the open face gun case of the invention mounted thereon in an operative position;

FIG. 2 is an isolated, perspective view of the open face gun case of the invention with mounting hardware situated such that, in the illustrated embodiment of FIG. 1, the case would be mounted on the passenger side of the vehicle;

FIG. 2A is an isolated, partial cross sectional view of a portion of the gun case, showing the padded and fleece layers which line the interior of the case;

FIG. 3 is side, partial cross sectional view of the open face gun case of the invention, the case being shown containing a representative firearm representing the normally secured position of the firearm; and

FIG. 4 is a front view of the gun case of the invention, the case being shown as containing a representative firearm that is secured in the retrievable position.

### DETAILED DESCRIPTION OF THE INVENTION

The preferred version of the invention presented in the following written description and the various features and advantageous details thereof are explained more fully with reference to the non-limiting examples included in the accompanying drawings and as detailed in the description which follows. Descriptions of well-known components and processes and manufacturing techniques are omitted so as to not unnecessarily obscure the principal features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

As has been briefly described, the open face gun case of the invention is designed to hold firearms, and particularly long guns, in a secure, yet readily available location inside or on a vehicle. It is particularly well adapted as a secure enclosure for mounting a long gun on an exterior location of an all terrain vehicle (ATV), but also lends itself to being used in a variety of vehicles. The gun case of the invention securely holds a long gun in a position which may be easily accessed by the driver or passenger of the vehicle and therefore rapidly put into use.

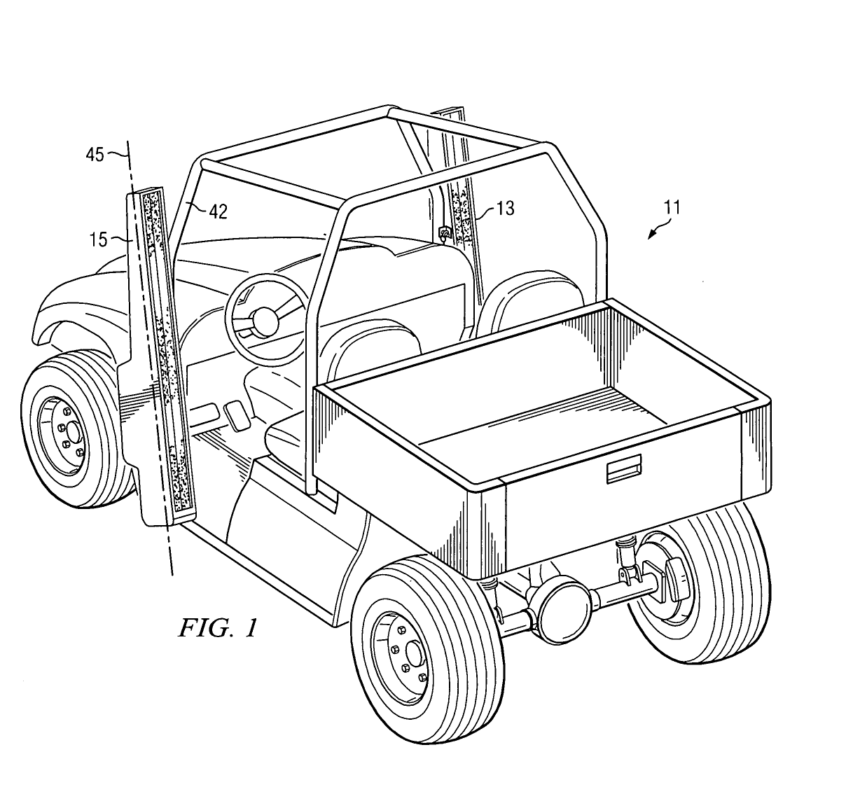

Referring now to FIG. 1 of the drawings, there is shown a typical ATV, designated generally as 11, of the type which is commercially available and widely used by hunters and others at the present time. The ATV, in this case, has a pair of the open face gun cases of the invention, designated as 13, 15 mounted on either side of the ATV on exterior locations, generally adjacent the driver side and passenger side door openings of the vehicle.

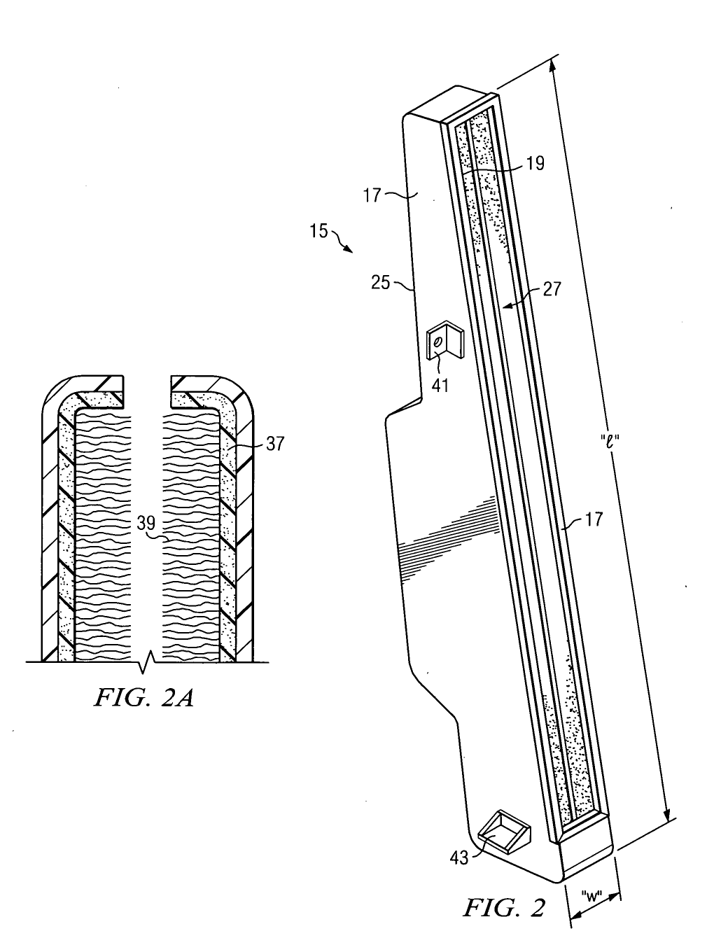

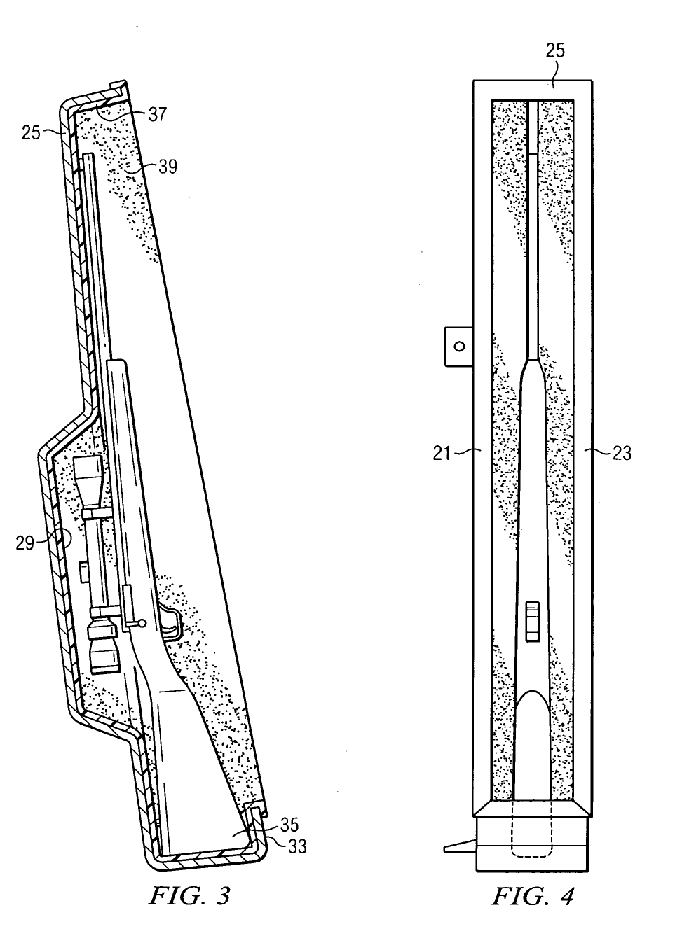

FIG. 2 shows one of the open face gun cases 15 in isolated, perspective fashion. As will be apparent from FIG. 2, the gun case 15 is made up of an elongate body 17 having a length “l” and width “w” sufficient to accommodate a long gun style firearm. By “long gun” is generally meant rifles, shotguns, and other guns with elongate barrels, most preferably a rifle, and particularly a scoped rifle. FIG. 3 of the drawings shows a traditional hunting rifle with a scope housed within the case of the invention. However, it should be understood that the case of the invention has particularly applicability for housing a scoped AR-15 and M-4 type “military” style rifle which are becoming ever increasingly popular for sport hunting purposes.

Returning to FIG. 2, the elongate body of the case of the invention has an exterior 17 and an interior 19 which is defined by a pair of parallel side panels (21, 23 in FIG. 4) separated by a back panel 25, the side panels 21,23 being arranged generally perpendicular to the back panel. The body is also defined by a fixed elongated front opening (generally 27 in FIG. 2), located opposite the back panel 25 and running for substantially the length of the body, which allows insertion and removal of a firearm without requiring unlatching of the front opening. As will be described in greater detail, the interior 27 of the body 15 is lined with a resilient engagement material which holds the firearm in place during transport of the case. A particularly preferred resilient engagement material is a poly fiber material lined with fleece.

As shown in FIG. 3, the back panel 25 includes a recessed region 29 which flares outwardly, as viewed in cross section in FIG. 3. This recessed region 29 is designed to accommodate a rifle scope, as shown in the drawing. The elongate body also has a boot region (generally at 33 in FIG. 3) which retains a stock portion, or butt 35, of the firearm, whereby retrieving the firearm from the case interior requires rotating the firearm in the direction of the elongate front opening and lifting it out of the captive boot region. The boot region provides a front lip at the lowermost extent of the elongated front opening 27.

The case of the invention thus includes a rigid cover member (body 15) and a two component, soft inner liner (illustrated as 37, 39 in FIG. 3). The cover member or body 15 is preferably made of metal, or a durable plastic or be of composite construction or a laminate. For example, the outer shell can be 5052 alloy ⅛″ aluminum with a 0.080 aluminum filler that is welded from the inside. The outside is then sprayed with a polyurethane spray coating with Trim Lock® mounding around the edge. However, the outer cover member of body could be made from a variety of durable materials such as a commercially available, durable exterior black plastic or vinyl product.

The cover member can generally be colored to match or complement the gun or the vehicle, or painted in a green camouflage pattern to reduce visibility in the field, or painted a fluorescent color for clear visibility in the field. Even though it is lightweight, this hard cover member protects the gun inside from hard bumps and vibration as the vehicle traverses rough terrain. It also reduces the possibility of an accidental discharge if the gun is jarred. The preferred outer cover member is durable, and is resistant to rusting, scratching, scuffing and fading. It is also waterproof.

As shown in FIGS. 2 and 2A, attached to the inside of the hard outer cover or body 15 is a protective padded liner illustrated as 37, 39 in FIGS. 2 and 2A. The inner liner is preferably made of a relatively soft, durable, weather-resistant, quick-drying material. One liner arrangement which has been used successfully is a 1″ thick poly fiber pad which is sewn to a ¾″ thick long black fleece material, both being custom sewn to fit the shape of the case and then fixed in position with contact cement. It is possible that the liner could also be made to be removable through the use of hook and loop type fasteners or other fastening systems. One commercially available fiber pad is sold as Nu-Foam™ supplied by Fairfield Processing of Deerfield, Conn., and is described as a premium density batting made of compressed layers of poly-fil polyester fiber. The liner lightly holds the gun in the case, protects the finish of the gun from scratching, and protects against the slight shocks that can throw off scope alignment.

As will be appreciated from FIG. 2A, the padded liner 37 has attached thereto a front layer of the fleece fiber 39. The fleece fiber liner 39 is a fiber or strand type material which provides a frictional-like engagement action when the firearm is inserted into the case. The outwardly extending fleece strands (39 in FIG. 2A) exert a soft, cushiony restraining action and also help to provide a type of “seal” to the longitudinal opening of the body, without presenting some form of lock or attachment which must be unlatched to gain access to the firearm. This provides a more weather resistant character to the case interior.

As will be apparent from FIG. 1, the present device can be mounted vertically, for example, behind the passenger seat in a car or truck, or horizontally. However, the gun case of the invention is preferably mounted at a slight angle from the vertical on an external location of an ATV. More than one case can be mounted on the typical ATV, as shown in FIG. 1 of the drawings. The gun owner's hands are free to operate the vehicle.

Referring to FIG. 2, the sidewall 17 holds a mechanism for attachment of the case 15 to the ATV. In the embodiment shown in FIG. 2, an angle bracket 41 and shelf element 43 are shown for attaching the elongate body to one of the cage supports (42 in FIG. 1) of the ATV. The case is also versatile in that it can easily be detached from one vehicle, such as a truck driven to a hunting lodge, and attached to another vehicle, such as an ATV kept at the lodge. The case of the present invention can be mounted on four wheelers, tractors, carts, jeeps, boats, and deer stands, for example. Another benefit of the device is that in cold weather the preferred aluminum shell and padded liner hold heat generated by the moving vehicle. This keeps the gun inside relatively warm, so that the user's fingers are not incapacitated by cold metal when they first contact the gun metal. This varies according to where the case is located in or on the vehicle.

FIG. 1 illustrates the preferred mounting location for the gun case of the invention. As will be appreciated from FIG. 1, the case is mounted on an exterior location on the ATV, the case being mounted in a preselected position which is rotated forward of a vertical axis to an inclined axis (45 in FIG. 1) away from the vehicle interior, and away from the driver side and passenger side, whereby the firearm is partly retained in the case interior by gravity. The boot region 33 of the case interior also serves to retains a stock portion (butt) of the firearm, whereby retrieving the firearm from the case interior requires rotating the firearm in the direction of the elongate front opening and lifting it out of the captive boot region. The firearm is held within the interior of the gun case by gravity and contact with the fleece lining in combination with the boot region located at the bottom of the case interior.

An invention has been provided with several advantages. The open face gun case of the invention is simple in design and economical to manufacture. The case has an open longitudinal seam along the front face to provide ease of access. The padded fleece lining and boot region of the case securely hold a firearm for transport, but allow easy and quick access to the firearm when need arises. It is not necessary to unlatch a lock or strap, since the firearm is held in place by the combination of the effect of the force of gravity, contact with the fleece lining and due to the position of the boot region of the device.

While the invention has been shown in only one of its forms, it is not thus limited but is susceptible to various changes and modifications without departing from the spirit thereof.

What is claimed is:

1. An easily accessible, vehicle mounted firearm case, comprising:
an elongate body having a length and width sufficient to accommodate a long gun style firearm, the elongate body having an exterior and an interior which is defined by a pair of parallel side panels separated by a back panel, and by a fixed elongated front opening, located opposite the back panel which allows insertion and removal of a firearm without requiring unlatching of the front opening;
wherein the interior of the body is lined with a resilient engagement material which holds the firearm in place during transport of the case.

2. The firearm case of claim 1 wherein the resilient engagement material is a poly fiber material lined with fleece.

3. The firearm case of claim 2, wherein a boot region is formed adjacent a lower extent of the elongated front opening which helps to retain a firearm placed within the case interior.

4. The firearm case of claim 3, wherein the back panel of the elongate body flares outwardly to form a receptacle for a rifle scope.

5. In combination, an all-terrain vehicle having an exterior and an interior with a driver side and a passenger side and an easily accessible, vehicle mounted firearm case for a long gun style firearm, the combination comprising:
an elongate body having a length and width sufficient to accommodate a long gun style firearm, the elongate body having an exterior and an interior which is defined by a pair of parallel side panels separated by a back panel which is arranged generally perpendicular thereto, and by a fixed elongated front opening, located opposite the back panel which allows insertion and removal of a firearm without requiring unlatching of the front opening, the interior of the body being lined with a resilient engagement material which holds the firearm in place during transport of the case, the rear wall having an outer flared extent which is designed to accommodate a firearm scope;
mounting hardware for mounting the firearm case on an exterior location on the ATV, the case being mounted in a preselected position which is rotated forward of a vertical axis away from the vehicle interior, and away from the driver side and passenger side, whereby the firearm is partly retained in the case interior by gravity.

6. The combination of claim 5, wherein the case interior has a boot region which retains a butt portion of a firearm, whereby retrieving the firearm from the case interior requires rotating the firearm in the direction of the elongate front opening and lifting it out of the captive boot region.

7. The combination of claim 6, wherein the resilient engagement material which lines the case is a poly fiber backing material which is itself lined with fleece.

8. The combination of claim 7, wherein the firearm is held within the interior of the gun case by gravity and contact with the fleece lining in combination with the boot region located at the bottom of the case interior.
